(19) United States
(12) Patent Application Publication
(10) Pub. No.: US 2008/0006700 A1
(43) Pub. Date: Jan. 10, 2008

(54) Method and apparatus for identifying and scheduling medicine intake

(75) Inventors: Christopher Zegelin, San Jose, CA (US); Rajiv Mehta, Los Altos, CA (US); Priya Kamani, San Francisco, CA (US)

Correspondence Address: PERKINS COIE LLP, P.O. BOX 2168, MENLO PARK, CA, 94026, US

(73) Assignee: ZUME LIFE, Los Altos, CA (US)

(21) Appl. No.: 11/825,675

(22) Filed: Jul. 6, 2007

Related U.S. Application Data
(60) Provisional application No. 60/818,738, filed on Jul. 6, 2006.

(51) Int. Cl. G06K 7/10; G08B 3/10

(52) U.S. Cl. 235/472.02; 340/870.09; 368/12; 705/2

(57) ABSTRACT

A novel system and method for identifying objects uses a device, such as a pen. The device has integrated components and wireless access to identify objects according to stickers placed on the objects.

### RELATED APPLICATIONS

This application claims priority to U.S. Provisional Patent Application No. 60/818,738, filed Jul. 6, 2006, and entitled “Method and Apparatus for a Health-Monitoring System using a Wireless Pen,” by C. Zegelin, et al., which is incorporated herein by reference.

### BACKGROUND

A number of problems arise in taking medicine. Individuals need to remember to take medicine. They need to take just the right amount. Some individuals even take the wrong medicine if not prevented from doing so.

Many individuals take medicine on a schedule. Often times this schedule is regimented and involves a number of different medicines. The complexity makes remembering which medicines to take at which times difficult for individuals.

Caregivers sometimes create medicine schedules for the individuals. This requires that individuals have a caregiver. However, caregivers are in short supply and are expensive. Further, some individuals cannot remember to look at the schedule. This requires a caregiver to be present to look at the schedule for the individual as well as encourage the individual to take the medicine.

In identifying medicine, pill bottles all look the same to some individuals. The labeling on the bottles is small and sometimes difficult for to read. Individuals can misidentify medicine. This is dangerous because individuals who take many pills could become ill or overdose by taking the wrong medicine.

The foregoing examples of the related art and limitations related herewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A novel system and method use stickers and a device to identify objects. A device identifies the objects by the stickers placed on the objects.

In the case of identifying medicine, stickers are used to identify medicine by placing the stickers on medicine containers. The stickers are used to regulate the time and dosage of the individual's intake of one or more medicines. The schedule is prepared according to a predetermined prescription issued by the individual's doctor. The device has integrated communication means and wireless access to communicate with caregivers and doctors.

In using the device, stickers are placed on the medicine containers to identify the medicine to the device. The device monitors the schedule for the medicine. At the appropriate time, the device notifies the individual to take the medicine. The individual places the device near the sticker. There the device identifies the medicine by the sticker attached to the medicine container. The device determines whether the medicine is the correct medicine or not. If the medicine is incorrect, the user is warned not to take it.

### BRIEF DESCRIPTION OF THE DRAWINGS

Embodiments of the inventions are illustrated in the figures. However, the embodiments and figures are illustrative rather than limiting; they provide examples of the inventions.

FIG. 1 depicts an example of a system 100 for identifying objects using a wireless device.

FIG. 2 depicts a flowchart 200 of an example of a method of identifying medicine and scheduling medicine intake.

FIG. 3 depicts an example of a device 300 including a plurality of integrated devices.

FIG. 4 depicts a flowchart 400 of an example of a method for using a wireless device to identify medicine and schedule intake.

FIG. 5 depicts an example of system 500 including a wireless device tapping a medicine container while a camera of the wireless device takes a picture of a sticker on the medicine container to identify medicine.

FIG. 6 depicts an example system 600 including an individual talking to a caregiver who gives advice to the individual over the internet via a wireless device.

FIG. 7 depicts an example of a wireless pen 700 including a plurality of integrated devices.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

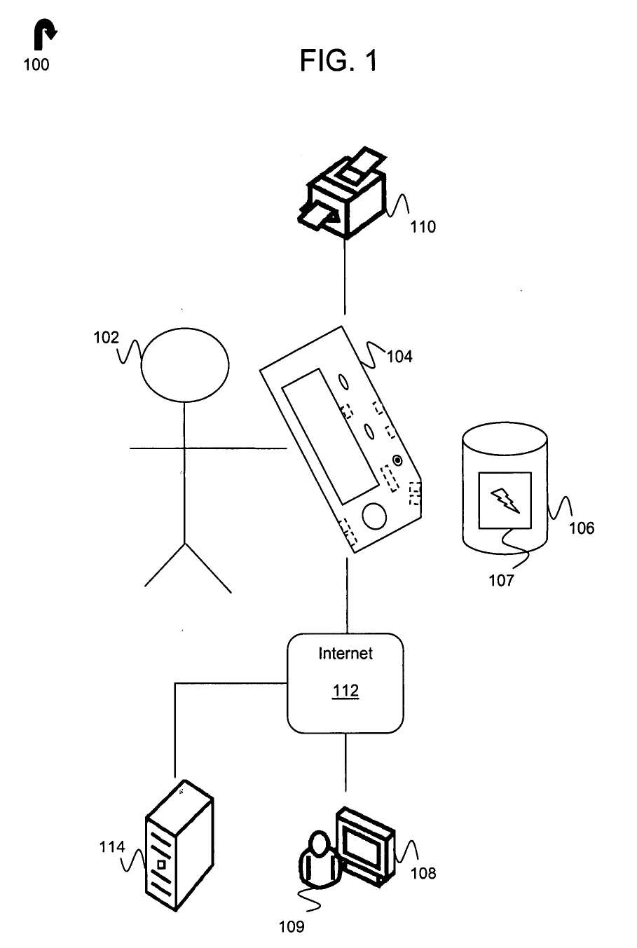

FIG. 1 depicts an example of a system 100 for identifying and scheduling medicine intake using a wireless device. Although this illustration depicts components as functionally separate, such depiction is merely for illustrative purposes. Those skilled in the art know that the components portrayed in this figure can be arbitrarily combined or divided into separate software, firmware, and/or other hardware components. Furthermore, such components, regardless of how they are combined or divided, can execute on the same computing device or multiple computing devices wherein the multiple computing devices can be connected by one or more networks.

The system 100 includes individual 102, wireless device 104, object 106, sticker 107, remote terminal 108, caregiver 109, printer 110, internet 112, and server 114. In the example of FIG. 1 object 104 could be any number of different items, such as medicine, household appliances, pictures, picture frames, doors, food items, and any other item that individual 102 may wish to identify using system 100. In operation, individual 102 places wireless device 104 near object 106. Wireless device 104 identifies object 106; e.g. individual 102 places sticker 107 on a picture frame, places wireless device 104 near sticker 107, then wireless device 104 alerts individual 102 as to the contents of the picture frame. In this example of a picture frame, the device could say “this is a picture of your granddaughter.”

In an illustrative embodiment, individual 102 has a medicine schedule which requires her to take certain medicines at certain times. The wireless device 104 knows the schedule, and is wirelessly connected to printer 110 for printing the medicine schedule and related information. Object 106 is a medicine container. Object 106 has sticker 107 attached to it for identification. Individual 102 is alerted by wireless device 104 that it is time to take her medicine. Individual 102 taps wireless device 104 against sticker 107 and wireless device 104 identifies the medicine in object 106. Wireless device 104 determines that the medicine contained in medicine container 106 is the correct medicine. Individual 102 then takes medicine from object 106.

In some embodiments, wireless device 104 transmits a note to printer 110 which prints the note stating that the medicine has been taken, a report of the medicine taken, or a schedule of medicine to take. Wireless device 104 communicates with remote terminal 108 to notify caregiver 109 that the medicine has been taken. Also, server 114 stores a record that the medicine has been taken.

In some embodiments, the medicine is not the correct medicine. In the case that individual 102 taps wireless device 104 against the wrong medicine, then wireless device 104 sounds an alert to notify individual 102 that the medicine in the medicine container 106 is not the correct medicine. Individual 102 may then attempt to find the correct medicine for her schedule.

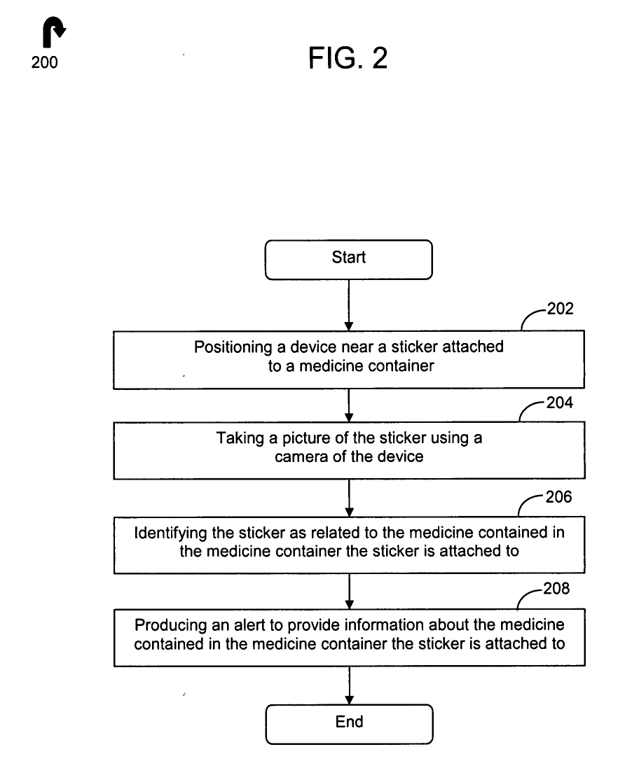

FIG. 2 depicts a flowchart 200 of an example of a method of identifying medicine and scheduling medicine intake. Although this figure depicts functional steps in a particular order for the purposes of illustration, the process is not limited to any particular order or arrangement of steps. One skilled in the art will appreciate that the various steps portrayed in this figure could be omitted, rearranged, combined and/or adapted in various ways.

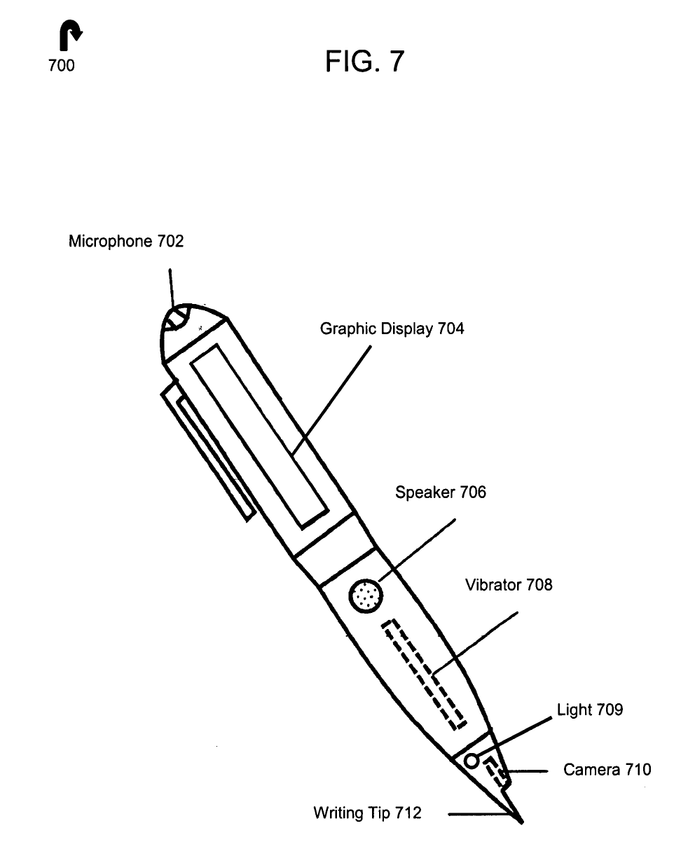

In the example of FIG. 2, the flowchart starts at module 202 with positioning a device near a sticker attached to a medicine container. In this example, medicine container contains medicine which is part of a medication schedule, and an individual is using the device to identify the medicine in a medicine container based on the attached sticker. In a non-limiting embodiment, the wireless device described in relation to FIG. 1 is the device. The device may also be configured as a pen, such as shown and described in regard to FIG. 7.

In the example of FIG. 2, the flowchart continues to module 204 with taking a picture of the sticker using a camera of the device. In this example, the device has an integrated camera as well as local storage for an image that is taken by the camera. The image is stored in the local storage for use in future steps.

In the example of FIG. 2, the flowchart continues to module 206 with identifying the sticker as related to the medicine contained in the medicine container the sticker is attached to. The device has related image recognition software as well as a file of stored images to match the image from the camera to. In this example, the image taken by the camera is compared with images on file to find a match with a particular image. Medicine is associated with the image on file, and once the image is recognized, the medicine stored in the medicine container is identified.

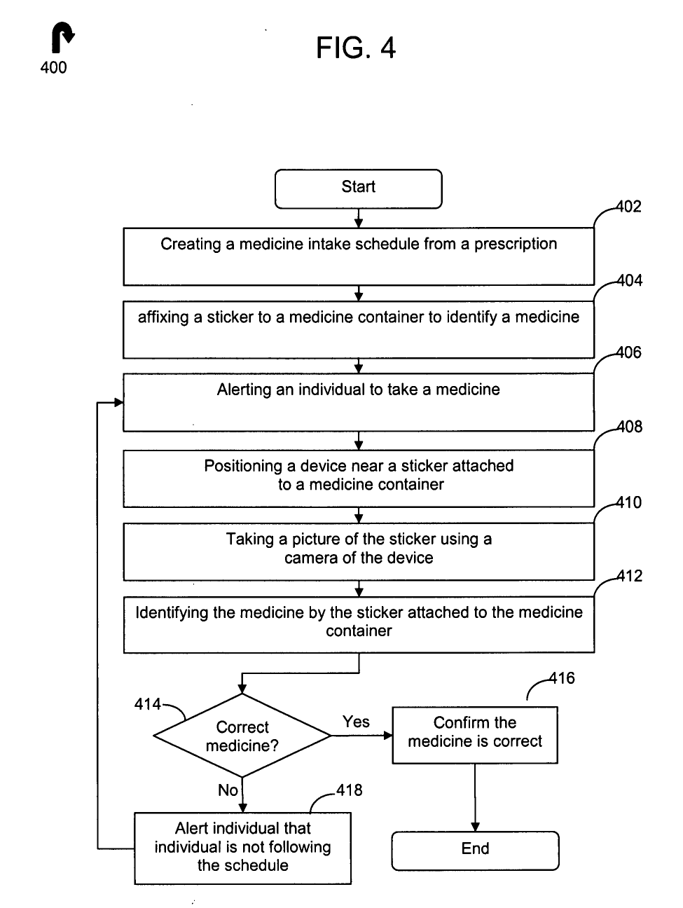

In the example of FIG. 2, the flowchart continues to module 208 with producing an alert to provide information about the medicine contained in the medicine container the sticker is attached to. In this example, the medicine is the correct medicine, and the user is alerted that the medicine is correct and should be taken. A discussion of FIG. 4 explains what to do when the medicine is not correct.

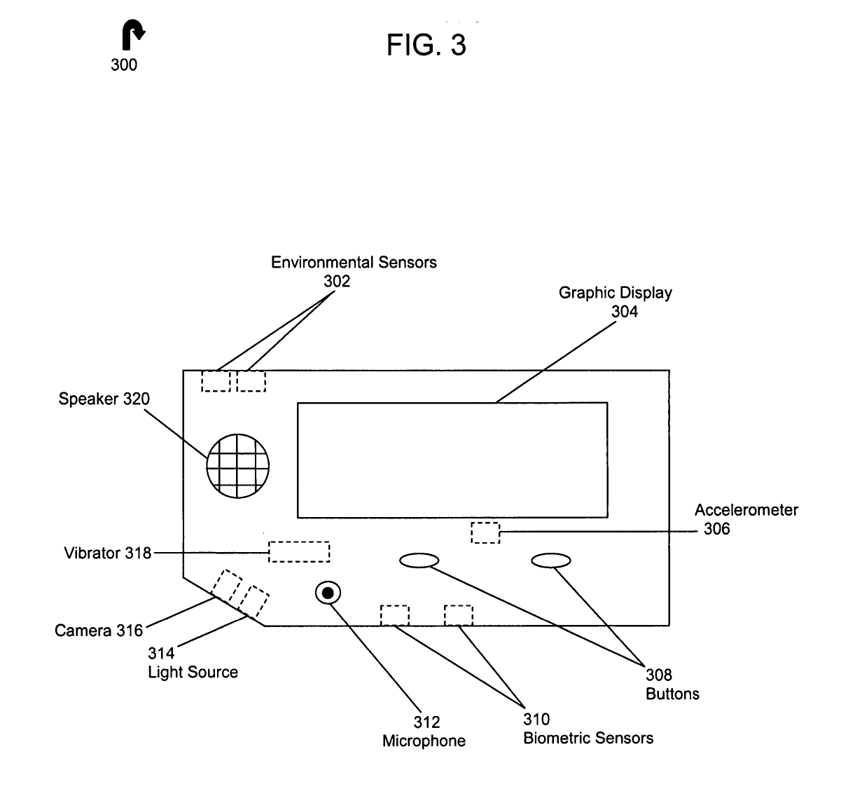

FIG. 3 depicts an example of a device 300 including a plurality of integrated devices. The device 300 includes environmental sensors 302, graphic display 304, accelerometer 306, buttons 308, biometric sensors 310, microphone 312, light source 314, camera 316, vibrator 318, and speaker 320.

In the example of FIG. 3, environmental sensors 302 can be used to ascertain a user's health, ambient temperature, motion of the device and other environmental conditions may be collected. Device 300 may be a wireless device that communicates wirelessly with other devices. Graphic display 304 can be used to provide information about medicine that is to be taken, information regarding an object identified by a sticker, incoming messages to the user and a variety of other information. Accelerometer 306 can be used to provide information to wireless device 300 about the movements of wireless device 300. Accelerometer 306 can also be used to provide information used to ascertain a user's health. Buttons 308 receive user input to cause wireless device to perform functions.

In the example of FIG. 3, Biometric sensors 310 may be any of, but not limited to temperature, pressure (such as pressure from grip), blood pressure, conductivity, and a pulse sensor. Microphone 312 receives user voice and other sounds. Light source 314 provides a light for camera 316. Light source 314 may be a flash. Camera 316 may be used for taking pictures, e.g. for taking a picture of a sticker to identify an object. Vibrator 318 may be used to silently alert an individual with a medicine schedule, incoming messages, or another user specified alert. Speaker 320 projects alerts and recordings. Speaker 320 can be used to communicate using VOIP wherein a remote person's voice is projected to an individual using the device.

FIG. 4 depicts a flowchart 400 of an example of a method for using a wireless device to identify medicine and schedule intake. Although this figure depicts functional steps in a particular order for the purposes of illustration, the process is not limited to any particular order or arrangement of steps. One skilled in the art will appreciate that the various steps in this figure could be omitted, rearranged, combined, and/or adapted in various ways.

In the example of FIG. 4, the flowchart starts at module 402 with creating a medicine intake schedule from a prescription. The prescription is created by the individual's doctor, and may be provided to the individual. In an illustrative embodiment, the prescription may be electronically provided to the patient and stored in a server. The prescription dictates the times and dosages of the medicine to be taken. The medicine intake schedule lists times and relevant information, e.g. a number of pills to take at the specified times. The medicine intake schedule, or part of the schedule, is stored on a device the individual can use as part of her health monitoring system.

In the example of FIG. 4, the flowchart continues to module 404 with affixing a sticker to a medicine container to identify a medicine. In an illustrative embodiment, the sticker is an adhesive based sticker bearing an image. The image is associated with a medicine. The medicine is identified by the image on the sticker. Other methods of identifying a medicine using a sticker are contemplated, e.g. barcodes, embedded chip, or other forms of attaching an identifying sticker which can quickly and easily be recognized.

In the example of FIG. 4, the flowchart continues to module 406 with alerting an individual to take a medicine. This alert can be auditory, by text, light, vibration, or any other means of getting an individual's attention. The alert is timed by the schedule, and occurs at or before the time that the individual is required to take her medication. In an illustrative embodiment, the alert sounds 5 minutes before it is time to take the medicine so that the individual is able to prepare to take the medicine. The timing of the alert may be changed as is convenient or desirable.

In the example of FIG. 4, the flowchart continues to module 408 with positioning a device near a sticker attached to a medicine container. This positioning could be pointing at, tapping, swiping, or otherwise bringing a device into a close proximity with the sticker. In an illustrative embodiment, the device is tapped against the sticker. Tapping both brings the device near the sticker and provides the individual with a specific action to take that can be mentally associated with determining the contents of the medicine container.

In the example of FIG. 4, the flowchart continues to module 410 with taking a picture of the sticker using a camera of the device. The camera being in close proximity to the sticker is able to capture the image on the sticker.

In the example of FIG. 4, the flowchart continues to module 412 with identifying the medicine by the sticker attached to the medicine container. Image recognition software associated with the device will associate the picture taken with the camera and a picture on file. This association will be used to determine a medicine contained in the medicine container to which the sticker is attached to.

In the example of FIG. 4, the flowchart continues to module 414 with determining whether the medicine is the correct medicine to take or not according to the medicine intake schedule. Once the medicine has been identified, the device compares the medicine with the medicine listed on the schedule. If the medicine does not match, then the device assumes that the incorrect medicine has been selected. If the medicine does match, then the device assumes that the correct medicine has been selected. This decision is made based on the sticker. It is a requirement that the correct sticker be applied to the correct medicine container.

In the example of FIG. 4, if the correct medicine was selected, the flowchart continues to module 416 with confirming the medicine is correct. This confirmation could be an alert to notify the individual that the medicine is the correct medicine. E.g. the device makes a noise, vibrates, displays text, or otherwise alerts the individual that the medicine is correct.

In the example of FIG. 4, if the incorrect medicine was selected, the flowchart continues to module 418 with alerting the individual that the individual is not following the schedule. The medicine is incorrect. The individual is notified that the wrong medicine has been selected. This will prevent the individual from taking the wrong medicine.

In the example of FIG. 4, the flowchart then continues back to module 406 with alerting an individual to take a medicine. This will prompt the individual to proceed through modules 408, 410, 412, 414, and 416 to the end. This will assure that the individual takes the correct medicine.

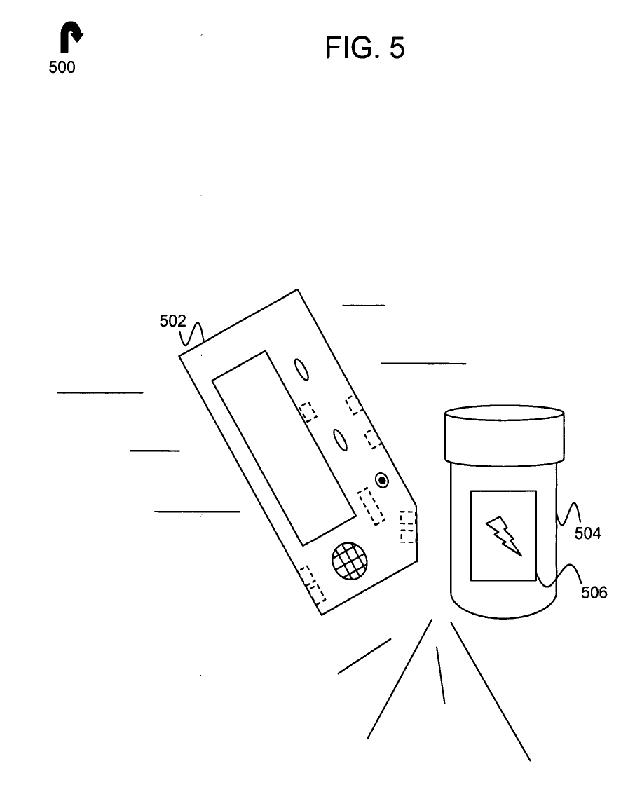

In some embodiments a wireless device is the device as discussed in reference to FIG. 4 and the wireless device is used to tap against a sticker on a medicine container to identify the medicine contained in the medicine container. FIG. 5 depicts an example of system 500 including a wireless device tapping a medicine container while a camera of the device takes a picture of a sticker on the medicine container to identify medicine. In the example of FIG. 5 system 500 includes wireless device 502, medicine container 504, and sticker 506. In the example of FIG. 5, wireless device 502 is tapped against sticker 506 located on medicine container 504. This places wireless device 502 in close proximity to sticker 506 on medicine container 504 so that wireless device 502 can identify sticker 506, such as by taking a picture of sticker 506 and using image recognition software to identify medicine in medicine container 504.

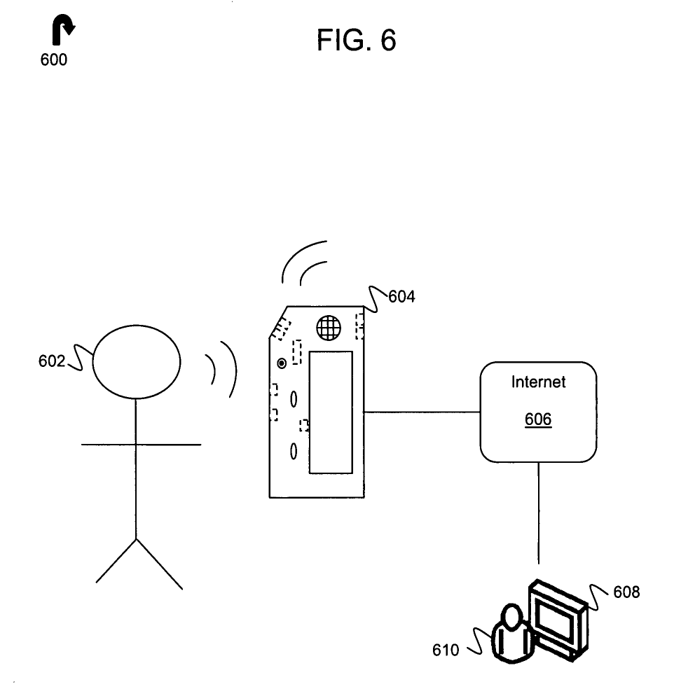

In some embodiments a wireless device is used to communicate with a caregiver or doctor. FIG. 6 depicts an example system 600 including an individual talking to a caregiver who gives advice to the individual over the internet via a wireless device. In the example of FIG. 6 system 600 includes individual 602, wireless device 604, internet 606, remote terminal 608 and caregiver 610. In the example of FIG. 6 Individual 602 speaks into a microphone integrated into wireless device 604, and that voice is digitized and transmitted over internet 606, e.g. via VOIP, or a digital voice transmission protocol having a higher fidelity than VOIP. Caregiver 610 hears the voice of individual 602 through remote terminal 608. Caregiver 610 may communicate through a microphone of remote terminal 608. Wireless device 604 projects the voice of caregiver 608 via a speaker so that individual 602 may hear caregiver 610.

FIG. 7 depicts an example of a wireless pen 700 including a plurality of integrated devices. Although this illustration depicts components as functionally separate, such depiction is merely for illustrative purposes. Those skilled in the art know that the components portrayed in this figure can be arbitrarily combined or divided into separate software, firmware, and/or hardware components. Furthermore, such components, regardless of how they are combined or divided, can execute on the same computing device or multiple computing devices, and wherein the multiple computing devices can be connected by one or more networks.

In the example of FIG. 7 the wireless pen 700 includes microphone 702, graphic display 704, speaker 706, vibrator 708, light 709, camera 710, and writing tip 712. Here the microphone 702 can be used for receiving instructions to the pen, or recording voice, and even communicating in an outbound manner over the internet to caregivers, doctors, or other persons, e.g. via voice over internet protocol (VOIP) or similar means of transmitting voice. Graphic display provides characters to an individual using the pen. In a non-limiting embodiment, the display has two rows of display. It can display either two rows of characters or one row of large characters. Speaker 706 projects alerts and recordings. Speaker 706 can be used to communicate using VOIP wherein a remote person's voice is projected to an individual using the pen. Vibrator 708 causes the pen to shake or vibrate in order to alert a user, such as in the case that the user needs to be alerted without using noise. Light 709 provides light, and/or a flash for camera 710 so that camera 710 may take a picture. Camera 710 is takes pictures, such as of stickers attached to medicine containers. Writing tip 712 can be a pen, a pencil, a marker, and any other device which can be used to handwrite with.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations, and equivalents as fall within the true scope of the present invention.

We claim:

1. A system for identifying objects comprising:
a device having a camera, a software component and a speaker; and
a sticker affixed to an object identifying the object, wherein the device is positioned in close proximity to the sticker and the device identifies the object.

2. The system of claim 1 further comprising:
a printer wirelessly connected to the device printing information relevant to the object.

3. The system of claim 1 further comprising:
a server connected to the device via an internet receiving information about the sticker affixed to the object.

4. The system of claim 3 further comprising:
a remote terminal connected to the server and connected to the device wherein a person communicates information relevant to the object to an individual.

5. A device for identifying and scheduling medicine intake comprising:
a housing;
a camera integrated into the housing operable to take a picture of a sticker affixed to a medicine container containing a medicine;
a speaker integrated into the housing providing audible alerts from the device to alert an individual with information related to the medicine; and
a software component embodied in a computer readable medium integrated into the housing directing the speaker to provide the audible alerts by processing the picture taken by the camera.

6. The device of claim 5 further comprising:
a microphone integrated into the housing for recording the voice of the individual and other sound from the individual.

7. The device of claim 5 further comprising:
a display integrated into the housing providing information to the individual regarding the medicine.

8. The device of claim 5 further comprising:
a writing tip integrated into an end of the housing, the writing tip comprises a pen, or a pencil.

9. A method for identifying and scheduling medicine intake comprising:
positioning a device near a sticker attached to a medicine container;
taking a picture of the sticker using a camera of the device;
identifying the sticker as related to the medicine contained in the medicine container the sticker is attached to; and
producing an alert to provide information about the medicine contained in the medicine container the sticker is attached to.

10. The method of claim 9 wherein the information comprises:
the name of the medicine, the most recent dosage of medicine taken, and the next dosage to be taken.

11. The method of claim 9 further comprising:
affixing the sticker to the medicine container to identify the medicine container prior to taking a picture of the sticker.

12. The method of claim 9 further comprising:
alerting an individual as to whether the medicine is correct or not.

13. The method of claim 9 further comprising:
advising an individual to take medicine audibly through a speaker of the device.

14. The method of claim 9 further comprising:
tapping the device against the sticker on the medicine container to position the device near to the sticker.

15. The method of claim 9 further comprising:
raising an alarm if an individual is not following a medicine schedule determined after identifying the sticker.

16. The method of claim 9 further comprising:
providing information to a caregiver regarding the alert.

17. The method of claim 9 further comprising:
responding by a caregiver to a question or concerns of the individual by an audio function the device.

18. A program for identifying and scheduling medicine intake embodied in a computer readable medium that when executed cause a system to:
take a picture of a sticker using a camera of a device positioned near a sticker on a medicine container;
identify the sticker as related to the medicine contained in the medicine container the sticker is attached to; and
produce an alert to provide information about the medicine contained in the medicine container the sticker is attached to.0

19. The program of claim 18 wherein the information comprises:
the name of the medicine, the most recent dosage of medicine taken, and the next dosage to be taken.

20. The program of claim 18 further comprising:
affixing the sticker to the medicine container to identify the medicine container prior to taking a picture of the sticker.

21. The program of claim 18 further comprising:
alerting an individual as to whether the medicine is correct or not.

22. The program of claim 18 further comprising:
advising an individual to take medicine audibly through a speaker of the device.

23. The program of claim 18 further comprising:
tapping the device against the sticker on the medicine container to position the device near to the sticker.

24. The program of claim 18 further comprising:
raising an alarm if an individual is not following a medicine schedule determined after identifying the sticker.

25. The program of claim 18 further comprising:
providing information to a caregiver regarding the alert.

26. The program of claim 18 further comprising:
responding by a caregiver to a question or concerns of the individual by an audio function the device.
